(19) United States
(12) Patent Application Publication
(10) Pub. No.: US 2026/0352742 A1
(43) Pub. Date: Nov. 5, 2026

(54) A METHOD FOR CONFIGURING A COMMUNICATION SYSTEM BASED ON ANALYZING A COMPLIANCE REGARDING A SET OF RELIABILITY REQUIREMENTS FOR A SERVICE

(71) Applicant: Robert Bosch GmbH, Stuttgart (DE)

(72) Inventors: Guillaume Jornod, Frankfurt (DE); Ignacio Llatser Marti, Valencia (ES); Alexander Geraldy, Hildesheim (DE); Peter Engel, Hessisch Oldendorf (DE); Yiwen Yang, Hildesheim (DE)

(21) Appl. No.: 19/670,693

(22) Filed: May 7, 2026

(30) Foreign Application Priority Data
May 5, 2025 (DE) 10 2025 116 999.3

(51) Int. Cl. H04L 67/61; H04L 67/51

(52) U.S. Cl. CPC H04L 67/61; H04L 67/51

(57) ABSTRACT

A method for configuring a communication system based on analyzing a compliance regarding a set of reliability requirements for a service. The method includes: receiving a service request from a service function, the service request specifying a set of reliability requirements with respect to one or more quality of service parameters for the service being requested; analyzing a compliance regarding the set of reliability requirements with respect to the one or more quality of service parameters for the service request from the service function; and configuring a communication system assigned to the service provider, wherein the configuring is based on the analysis regarding the compliance for providing information for the service being requested.

### CROSS REFERENCE

The present application claims the benefit under 35 U.S.C. § 119 of Germany Patent Application No. DE 10 2025 116 999.3 filed on May 5, 2025, which is expressly incorporated herein by reference in its entirety.

### FIELD

The present disclosure relates to a method for configuring a communication system based on analyzing a compliance regarding a set of reliability requirements for a service. Furthermore, the present disclosure relates to a computer program, an apparatus, and a storage medium for this purpose.

### BACKGROUND INFORMATION

The exchange of V2X messages via V2X communication often allows vehicles and/or infrastructure components to exchange information among them, which enables the improvement of existing safety-critical applications and the development of new safety-critical applications to improve traffic safety and efficiency, and driver comfort, as well as a reliability improvement in existing driver assistance and automated driving applications. Examples can include Cooperative Automated Cruise Control (C-ACC), or V2X-based collision warning (e.g., due to a traffic jam ahead or a pedestrian crossing the street).

In current driving functions supported by V2X data, the driver is still responsible for reaction on V2X information, e.g., can decide if a reaction is necessary or slowly reduce the speed based on a collision warning without a safety level. Due to missing safety properties and performance guarantees of V2X communication, vehicles cannot use V2X data directly for safety-critical driving actions, e.g., to trigger hard braking (Automatic Emergency Braking, AEB) or steering maneuvers. If the V2X information could be trusted and could be taken as input from a safety point of view, then AD vehicles, no matter what AD level, could react automatically on V2X information, e.g., with hard braking or other difficult maneuvers like dodging, etc.

PCT Patent Application No. WO 2022/122450 A1 describes the inclusion of a “safety part” in V2X messages to enable their usability for safety-related driving functions. The safety part may include a safety level, failure rate, indication of development process, validity time, error model and/or confidence of the V2X data.

U.S. Patent Application Publication No. US 2019/0051151 A1 describes a control device to determine reliability of received V2X data based on statistical methods.

U.S. Patent Application Publication No. US 2021/255617 A1 describes a method for adapting Tele-operated Driving (ToD) control to predictive Quality of Service (pQoS) value to comply with functional safety.

Reliability is often another aspect of safety, which can be linked with the concept of Quality of service (QoS). QoS guarantees are often provided only for the domain controlled by a communication network. Hence, if safety-critical application entities communicate end-to-end via multiple communication technologies, the QoS guarantees provided by a single network, e.g., a 5G network, only consider a subset of the end-to-end communication.

Thus, end-to-end aware control mechanisms are still required at an application or a communication service level. Typically, having overarching communication network control mechanisms beyond systems is not practical, especially for communication services provided in wide area networks. Hence, the safety-critical applications rely mostly on their own end-to-end monitoring mechanisms.

It is an object of the present disclosure to at least partially overcome the disadvantages described above. In particular, it is an object of the present disclosure to provide a method for enabling applications to obtain a required reliability for the support of safety-critical applications.

### SUMMARY

According to aspects of the present disclosure, a method, a computer program, a data processing apparatus, and a computer-readable storage medium, are provided. Features and details of the subject matter of the present disclosure are disclosed herein. Features and details described in the context of the inventive method also correspond to the inventive computer program, the inventive data processing apparatus as well as the inventive computer-readable storage medium, and vice versa in each case.

According to an aspect of the present disclosure a method for configuring a communication system based on analyzing a compliance regarding a set of reliability requirements for a service is provided. According to an example embodiment, the method comprises the following steps carried out by a service provider:
Receiving a service request from a service function, the service request specifying a set of reliability requirements with respect to one or more quality of service parameters for the service being requested,
Analyzing a compliance regarding the set of reliability requirements with respect to the one or more quality of service parameters for the service request from the service function,
Configuring a communication system assigned to the service provider, wherein the configuring is based on the analysis regarding the compliance for providing information for the service being requested.

The requesting service function may be represented by an application which preferably requests a service from the service provider with a specific reliability with respect to one or more QoS parameters for the requested service. The service provider may be represented by another application which is adapted to offer one or multiple services and to receive the service request from the service function. The service function and/or the service provider may be embodied in a data processing apparatus, optionally comprised by a network element, e.g., a user equipment, a base station, an access point, or a core network element, or by a cloud computing system.

This has the advantage of enhancing reliability and efficiency in communication networks, such as for example, a V2X communication network, based on the inventive method. By explicitly defining service requirements and allowing for analyzing, service providers or applications can dynamically adjust their demands based on the capabilities of available service functions or service providers. This approach advantageously supports collaboration between providers or applications and promotes efficient resource utilization within the network. Furthermore, the overall compatibility allows for a seamless interoperability across diverse systems and vendors, paving the way for a more robust and interconnected communication ecosystem.

It is also possible that the receiving of the service request and/or any other message and/or notification by the service provider is performed via a dedicated interface of a communications network.

It is further possible that the dedicated interface can be designed as an air interface.

According to an example embodiment, it is possible that the method further comprises:
Receiving, from the service function, a negotiation request based on a received rejection message requesting a relaxation of one or more reliability requirements from the set of reliability requirements to enable a provision of the service based on the capabilities and/or limitations of the service function,
Initiating a negotiation procedure with the service function regarding the relaxation of the one or more reliability requirements for the requested service based on the received negotiation request.

Allowing for a negotiation of reliability requirements specified by a service function, the service providers such as for example applications can dynamically adjust their system based on the requirements of the service function. Further, this allows for fostering collaboration between service providers and service function(s) or between for example applications. Further, this advantageously promotes efficient resource utilization within the communications network. Furthermore, this has the advantage that the service providers can adapt their requirements based on the service function's requirements.

It is further possible that during the initiated negotiation procedure the method further comprises:
Receiving, from the service function, further information regarding its capabilities and/or its limitations,
Analyzing the further information and the initially specified set of reliability requirements with respect to one or more quality of service parameters, specifically to determine a new set of reliability requirements,
Determining one or more reducible reliability requirements based on the analysis.

This has the advantage that the service provider can adapt its capabilities based on the service function's requirements. This allows for a more flexible and dynamic negotiation process, leading to a higher likelihood of reaching an agreement that satisfies both parties. The analysis of information regarding limitations and reconfiguration options empowers the service function to make informed decisions about which reliability requirements are most crucial and which can be relaxed without compromising safety or reliability. This iterative approach advantageously enhances the efficiency and effectiveness of the negotiation process, ultimately leading to a more successful outcome for both the service provider and the service function.

It is also possible that after the determining, the method further comprises:
Sending a new set of reliability requirements to be agreed on based on the determined one or more reducible reliability requirements to the service function.

This allows the service provider to send an updated set of quality of service requirements to the service function reflecting the agreed-upon relaxations. This allows for a final agreement on the parameters for providing the requested service, ensuring both parties' needs are met within the constraints of the available resources and capabilities.

It is further possible that the method further comprises:
Receiving a confirmation message from the service function for providing the service based on the new set of reliability requirements,
Providing the service being requested via a communication channel to the service function in case the analysis shows that the new set of reliability requirements can be fulfilled.

This has the advantage that a successful agreement between the service provider and the service function can be reached. Thes agreement leads to the service provider confirming its ability to provide the service being requested based on the revised set of quality of service requirements agreed upon during the negotiation. The confirmation message signals that the service provider can now fulfill the request with the adjusted parameters.

It is also possible that the service request further specifies a fault definition and/or a time-window for providing the requested service.

This has the advantage that the service function can specify various aspects related to the service's performance and availability. This allows for more granular control over the service request, enabling the service function to clearly define its expectations regarding the reliability, latency, bandwidth, and other critical parameters. Furthermore, by specifying fault definitions, the service function can outline acceptable levels of error handling and recovery mechanisms within the service. Defining a time-window for service provision allows the service function to indicate specific periods to the service provider during which the service is required, enabling the service provider to plan and allocate resources accordingly.

It is further possible that the sending of the service request is performed via unicast, groupcast or broadcast.

This allows for sending or for receiving the service request when using various transmission methods such as unicast communication for direct interaction between two entities such as the service function and the service provider; groupcast communication for sending a message to a specific group of recipients such as a group of service providers, and broadcast communication for disseminating information to all connected entities such as (potential) service providers within the communications network. This flexibility allows the service function to choose the most appropriate transmission method based on the specific requirements of the service request and the intended recipients.

It is also possible that the method further comprises:
Sending an acceptance message to the service function in case the service function confirmed the provision of the requested service.

This has the advantage that upon successful negotiation and agreement on relaxed reliability requirements, the service provider sends a confirmation message to the service function. This message acknowledges acceptance of the adjusted service requirements and indicates readiness for service provisioning. This step finalizes the negotiation process and allows the service provider to commence fulfilling the service being requested based on the mutually agreed-upon terms.

In another aspect of the present disclosure, a computer program may be provided, in particular a computer program product, comprising instructions which, when the computer program is executed by a computer, cause the computer to carry out the method according to the present disclosure. Thus, the computer program according to the present disclosure can have the same advantages as have been described in detail with reference to a method according to the present disclosure.

In another aspect of the present disclosure, an apparatus for data processing may be provided, which is configured to execute the method according to the present disclosure. The apparatus may be, for example, a computer which is configured or adapted to execute the computer program according to the present disclosure. The computer may include at least one processor that can be used to execute the computer program. Also, a non-volatile data memory may be provided in which the computer program may be stored and from which the computer program may be read by the processor for being carried out.

According to another aspect of the present disclosure, a computer-readable storage medium may be provided which comprises the computer program according to the present disclosure and/or instructions which, when executed by a computer, cause the computer to carry out the steps of the method according to the present disclosure. The storage medium may be formed as a data storage device such as a hard disk and/or a non-volatile memory and/or a memory card and/or a solid state drive. The storage medium may, for example, be integrated into the computer.

Furthermore, the method according to the present disclosure may be implemented as a computer-implemented method.

Alternatively, or additionally, at least one of the disclosed method steps may be computer-implemented and/or automated.

Further advantages, features and details of the present disclosure will be apparent from the following description, in which embodiments of the present disclosure are described in detail with reference to the figures. In this context, the features mentioned herein may each be essential to the present disclosure individually or in any combination.

### BRIEF DESCRIPTION OF THE DRAWINGS

FIG. 1 shows a method, computer program, a storage medium and apparatus according to example embodiments of the present disclosure.

FIG. 2 shows a schematic diagram of an exemplary process according to example embodiments of the present disclosure.

In the following figures, the identical reference signs are used for the same technical features even for different embodiment examples.

### DETAILED DESCRIPTION OF EXAMPLE EMBODIMENTS

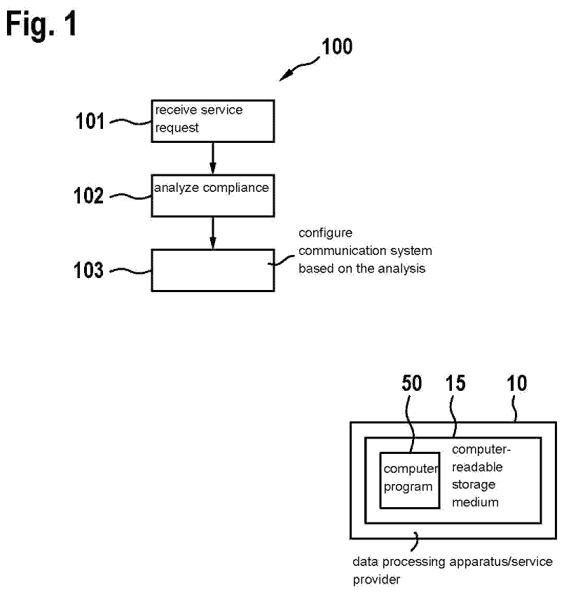

FIG. 1 shows a method, computer program, a storage medium and apparatus according to embodiments of the present disclosure. Particularly, FIG. 1 depicts a method 100 for analyzing a compliance regarding a set of reliability requirements for a service. The method 100 comprises the following steps carried out by a service provider 10: In a step 101 a service request from a service function 20 is received. The service request specifies a set of reliability requirements with respect to one or more quality of service parameters for the service being requested. In a step 102 a compliance is analyzed regarding the set of reliability requirements with respect to the one or more quality of service parameters for the service request from the service function 20. Then, in a step 103 the communication system is configured based on the analysis 102 regarding the compliance for providing information for the service being requested.

Further, a data processing apparatus 10 or a service provider 10, a computer-readable storage medium 15 and a computer program 50 are depicted in FIG. 1.

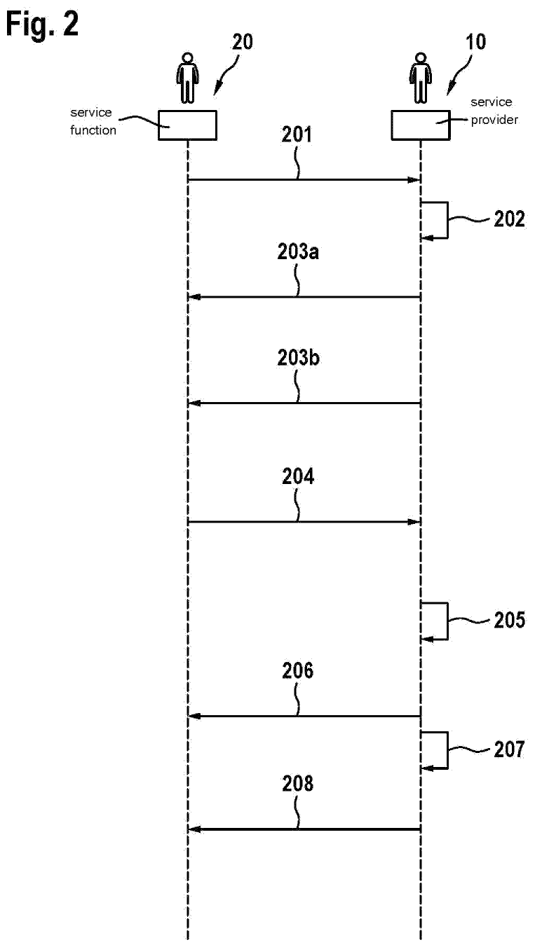

FIG. 2 shows a schematic diagram of an exemplary process according to embodiments of the present disclosure. In this embodiment illustrated in FIG. 2 the service provider 10 comprises for example an application B and the service function 20 comprises for example an application A. The exemplary process depicted in FIG. 2 shows a requesting from the application A to an application B for a specific reliability requirement with respect to one or more Quality of Service (QoS) parameters to support for example a vehicle-to-everything (V2X) service.

Application A as the service function 20 sends 201 a service request with respect to one or more Quality of Service (QoS) parameters to a second application B as the service provider 10 for a specific service, for example through a dedicated interface of the communications network. In other words, the service provider 10 can receive 201 the service request and this request specifies a set of reliability requirements with respect to the one or more quality of service parameters for the service being requested. The sending 201 of the service request can be performed by the service function 20 as a unicast communication. Alternatively, application A (service function 20) can also send 201 or communicate 201 its service request via broadcast communication to multiple applications. The service request can comprise information and/or a message format as described further below.

Application B as the service provider 10 may analyze 202 the service request and provides an answer 203a, 203 b to the application A. In case of acceptance, application B parametrizes 205 its communication system for the communication link or communication channel between application A and application B. This means application B (service provider 10) can support the service being requested and can fulfil the reliability requirements.

In other words, the service provider 10 (application B) can answer 203a, 203b to the service request with respect to its ability to fulfil the reliability requirements. For example, for a requested time interval (step 203 b) or the application B can answer that it can currently meet the reliability requirements without limitations (step 203a).

This also means that the service provider 10 can send 203b an answer message to the service function 20 or the application A comprising the information that it only fulfils a limited subset of the reliability requirements or application requirements for a certain time interval. In the worst case, the said subset can be zero, which means no reliability requirement can be fulfilled by application B. Further, application B can decide whether it can fulfil the requirements by reserving radio access network (RAN) resources, when it is using a 5G-RAT (radio access technology), according to the reliability requirements. Furthermore, application B as the service provider can decide whether it can fulfil the requirements based on observing 207 the current channel conditions, especially when using a non-managed communication technology.

If the application B as the service function 20 replies 203a to application A then no further alignment or negotiation is necessary, and the application B as the service provider 10 can operate 206 on the communications network according to its requirements meaning providing the service being requested. If the application B replies according to step 203b, a negotiation procedure can be initiated or started by the application A as the service function 20 to determine an alternative set of reliability requirements that fits the application B current capabilities (not depicted in FIG. 2).

During the negotiation procedure, the application A as the service function 20 may relax for example its reliability parameters with respect to one or more quality of service parameters and/or fault definitions and/or time-window under consideration of its internal safety- and reliability requirements and internal reconfiguration options. A fault can be understood as a point in time during which one or multiple requirements of a set of QoS-Parameters/functional requirements are not met. A QoS-Parameter/functional requirement is itself defined as a pre-defined communication property and a threshold (value+unit) that should be respected.

Further, the service provider 10 can exchange information, which can be used by the service function 20 to choose the most promising reliability requirements relaxation. For example, if the service provider 10 is already processing other service requests for example for the next five seconds but will be able to provide a lot of communication resources afterwards, a simple shift of the requested time-window could be a good relaxation option for the application A as the service function 20. The reason for which application B is not necessarily in the position to provide the service being requested and its respective QoS is mainly because of other requesting applications that are competing for the communication capabilities of application B and because of the limited spectrum resources.

Further, receiving the reliability request from application A the application B may transform the reliability requirements into a communication technology-specific set of parameters, for example, a modulation and coding scheme (MCS), numerologies or the like. It can also reserve more resources in case of a network supported communication technology.

Then in step 204 the application A may notify 204 the application B (the service provider 10) of its acceptance or rejection with respect to the answer 203a, 203b of application B.

As depicted in FIG. 2 application B as the service provider 10 may configure 205 its communication system to comply with the agreed requirements and can provide 206 the service being requested to application A.

In step 207 the service provider 10 can monitor 207 the provision of the service or the data on the communication channel between the service provider 10 and the service function 20.

If at some point in time the reliability requirements cannot be fulfilled anymore, the service provider 10 can notify 208 the service function 20, preferably in advance.

A reason for not being able to (further) comply with the reliability requirement can be for example a change in a setup of inter antenna distance or another user in the share medium (channel), or other requests for application B for the same service or for another service. Further, the non fulfilment may not only be due to channel disturbance. But application B can detect if it cannot reserve the appropriate resource or can adapt the modulation and coding scheme to the channel conditions, for example a pathloss from inter antenna distance.

Further, an example of an application can be a driving function or an automated valet parking function. An example of a service can be a Collective Perception Service (CPS), a Cooperative Awareness Service (CAS), a Maneuver Coordination Service (MCS) or any other service including the exchange of messages through a communication interface.

The service request can comprise the following bundle of information:
A list of quality of service (QoS) parameters,
   A “Fault definition” per QoS parameter, i.e., deviations in time and amplitude that are still considered acceptable from the specific applications perspective, for example:
      Max. Target Latency: 100 ms,
      Fault definition: >100 ms in more than 1 out of 5 subsequent transmissions (from application source to application sink),
      A reliability or quality of service requirement per QoS Parameter, i.e., a common reliability metric expressing a statistical probability with which no fault (according to the “fault definition”) will occur,
      e.g.: MTTF of >1000 h; Alternative metrics: Rate of Occurrence of Failure (ROCOF), Probability of Failure on Demand (POFOD),
      A time-window per tuple (1 tuple is at least one QoS Parameter+fault-definition plus reliability requirement), e.g.: for the next 15 seconds or from date-time [start: 2023/05/21-09:05:20] to [end: 2023/05/21-09:05:35]

A specific example for such a bundle of information can look as follows:

| QoS | | Reliability | Time- |
|---|---|---|---|
| Parameter | Fault Definition | Requirement | window |
| Latency | Latency > 100 ms within more | MTTF > | 30 sec |
| | than 1 out of 5 subsequent | 1000 h | |
| | transmissions | | |
| Packet error | PER > 10\hat{ } − 2 | MTTF > | 15 sec |
| rate (PER) | | 10000 h | |

The first line should be read as: for the next 30 seconds, the request comprises that “the latency is not more than 100 ms in more than 1 out of 5 transmissions with a MTTF of >1000 h”.

By mapping QoS parameters with reliability requirements like MTTF (Mean Time To Failures), MTTR (Mean Time To Repair), MTBF (Mean Time Between Failures), availability, redundancy, failure rate, fault tolerance, error correction and scalability, communication systems can be designed and evaluated to meet specific quality of service objectives.

Examples of communication properties or quality of service parameters can be the following:
Maximum latency,
Maximum message inter-reception time (and/or transmission interval, or interval
between two successive transmission or periodicity of transmission (of periodic
traffic)),
Maximum message loss within a time window,
Maximum packet error rate,
Maximum jitter,
Minimum bandwidth,
Minimum range,
Reliability (percentage of delivered messages),
Security parameter (integrity etc.).

The above explanation of the embodiments describes the present disclosure in the context of examples. Of course, individual features of the embodiments can be freely combined with each other, provided that this is technically reasonable, without leaving the scope of the present disclosure.

What is claimed is:

1. A method for configuring a communication system based on analyzing a compliance regarding a set of reliability requirements for a service, the method comprising the following steps carried out by a service provider:
receiving a service request from a service function, the service request specifying a set of reliability requirements with respect to one or more quality of service parameters for a service being requested;
analyzing a compliance regarding the set of reliability requirements with respect to the one or more quality of service parameters for the service request from the service function; and
configuring a communication system assigned to the service provider, wherein the configuring is based on a result of the analyzing regarding the compliance for providing information for the service being requested.

2. The method of claim 1, further comprising:
receiving, from the service function, a negotiation request based on a received rejection message requesting a relaxation of one or more reliability requirements from the set of reliability requirements to enable a provision of the service based on capabilities of the service function and/or limitations of the service function; and
initiating a negotiation procedure with the service function regarding the relaxation of the one or more reliability requirements for the requested service based on the received negotiation request.

3. The method of claim 2, wherein during the initiated negotiation procedure, performing the following steps:
receiving, from the service function, further information regarding the capabilities of the service function and/or the limitations of the service function;
analyzing the further information and the set of reliability requirements with respect to one or more quality of service parameters; and
determining one or more reducible reliability requirements based on a result of the analyzing of the further information and the specified set of reliability requirements.

4. The method of claim 3, wherein, after the determining of the one or more reducible reliability requirements, performing the following:
sending a new set of reliability requirements to be agreed on based on the determined one or more reducible reliability requirements to the service function.

5. The method of claim 4, further comprising:
receiving a confirmation message from the service function for providing the service based on the new set of reliability requirements;
providing the service being requested via a communication channel to the service function when an analysis shows that the new set of reliability requirements can be fulfilled.

6. The method of claim 1, wherein the service request further specifies a fault definition and/or a time-window for providing the requested service.

7. The method of claim 1, wherein the service request is sent via one of the following: unicast, groupcast, or broadcast.

8. The method of claim 1, further comprising:
sending an acceptance message to the service function in a case that the service function confirmed a provision of the requested service.

9. A data processing apparatus for configuring a communication system based on analyzing a compliance regarding a set of reliability requirements for a service, the data processing apparatus configured to perform the following steps for a service provider:
receiving a service request from a service function, the service request specifying a set of reliability requirements with respect to one or more quality of service parameters for a service being requested;
analyzing a compliance regarding the set of reliability requirements with respect to the one or more quality of service parameters for the service request from the service function; and
configuring a communication system assigned to the service provider, wherein the configuring is based on a result of the analyzing regarding the compliance for providing information for the service being requested.

10. A non-transitory computer-readable storage medium on which are stored instructions for configuring a communication system based on analyzing a compliance regarding a set of reliability requirements for a service, the instructions, when executed by a computer of a service provider, causing the computer to perform the following steps for the service provider:
receiving a service request from a service function, the service request specifying a set of reliability requirements with respect to one or more quality of service parameters for a service being requested;
analyzing a compliance regarding the set of reliability requirements with respect to the one or more quality of service parameters for the service request from the service function; and
configuring a communication system assigned to the service provider, wherein the configuring is based on a result of the analyzing regarding the compliance for providing information for the service being requested.
